(19) United States
(12) Patent Application Publication
(10) Pub. No.: US 2024/0070672 A1
(43) Pub. Date: Feb. 29, 2024

(54) AUTOMATED EVENT RISK ASSESSMENT SYSTEMS AND METHODS

(71) Applicant: FMR LLC, Boston, MA (US)

(72) Inventors: John Mariano, Boston, MA (US); Victor Christian, Boston, MA (US); Christopher Janes, Boston, MA (US); David Ferris, Boston, MA (US); Paul Howard, Boston, MA (US); Christopher Baril, Boston, MA (US)

(21) Appl. No.: 17/897,393

(22) Filed: Aug. 29, 2022

(51) Int. Cl. G06Q 20/40

(52) U.S. Cl. CPC G06Q 20/4016

(57) ABSTRACT

A computer-implemented method is provided for detecting actionable transaction risks. The method includes grouping an inbound event related to a transaction with a target event group and determining an actionable group of events that are deemed high risk and a non-actionable group of non-actionable events that are deemed low risk. The method also includes evaluating the target event group relative to the actionable and non-actionable groups of events. This includes computing a first distance between the target event group and the non-actionable group and a second distance between the target event group and actionable group. The first distance is compared with the second distance to determine if the target event group, including the inbound event, is closer to the actionable group or to the nonactionable group.

### TECHNICAL FIELD

This application relates generally to systems, methods and apparatuses, including computer program products, for detecting actionable transaction risks.

### BACKGROUND

Events are generated by multiple systems every minute across an enterprise. Large or small, companies in one manner or another need to evaluate these events for riskiness and identify those risks that require further investigation. Traditional approaches to evaluating and vetting events for riskiness involve performing evaluations at a single point in time, which can be cumbersome, error prone and inaccurate. For example, traditional approaches tend to generate a considerable number of false positives based on many existing detection scenarios. In recent years, events are increasing, which has a linear effect on labor, as more people are required to review and adjudicate identified risks associated with these events. Public sentiment has become less tolerant to appearances of preventable errors in event risk identification and assessment. In addition, as customers' expectations of financial services continue to rise and change and as technology and new business models emerge and evolve, risk evaluation need to accommodate the evolution of newer types of risk (e.g., model, cyber, and increasing action channels), all of which require new skills and tools.

### SUMMARY

To remedy the above shortcomings in today's market, the present invention provides systems and methods related to a risk assessment engine that evaluates and priorities risks. The risk assessment engine of the present invention can homogenize risk signals (e.g., events or risk items) generated by multiple products or services across an enterprise and form groups of similar risk signals evaluated in real time against current and historical information over multiple sources. These groups can be scored and prioritized in terms of risk in real time, which allows for identification of previously unknown risks/issues and expedite resolution. In some embodiments, the risk assessment engine is configured to collect, group and score current and adjudicated risk items in real time to present a relative risk profile over a period of time. In some embodiments, the risk assessment engine is configured to continually adapt and learn to optimize risk scoring over time. In some embodiments, the risk assessment engine leverages artificial intelligence (AI) and/or machine learning (ML) as a means to augment, identify and expedite outcomes. As a result, the risk solution of the present invention is able to make better risk decisions at lower operating costs while creating superior customer experiences.

In one aspect, the present application features a computer-implemented method for detecting actionable transaction risks. The method includes grouping, by the computing device, an inbound event related to a transaction with a target event group and determining, by the computing device, an actionable group of events that are deemed high risk and a non-actionable group of non-actionable events that are deemed low risk. The method also includes evaluating, by the computing device, the target event group relative to the actionable and non-actionable groups of events. Evaluating the target event group includes computing a first distance between the target event group and the non-actionable group. The first distance is a difference between (i) a first joint entropy value that measures a degree of uncertainty between the target event group and the non-actionable group and (ii) a first mutual information value that measures a degree of mutual dependence between the target event group and the non-actionable group. Evaluating the target event group also includes computing a second distance between the target event group and actionable group. The second distance is a difference between (i) a second joint entropy value that measures a degree of uncertainty between the target event group and the actionable group and (ii) a second mutual information value that measures a degree of mutual dependence between the target event group and non-actionable group. Evaluating the target event group further includes comparing the first distance with the second distance to determine if the target event group, including the inbound event, is closer to the actionable group or to the nonactionable group.

In another aspect, the invention features a computer program product, tangibly embodied in a non-transitory computer readable storage device, for detecting actionable transaction risks. The computer program product includes instructions operable to cause a computing device to group an inbound event related to a transaction with a target event group, determine an actionable group of events that are deemed high risk and a non-actionable group of non-actionable events that are deemed low risk, and evaluate the target event group relative to the actionable and non-actionable groups of events. The instructions operable to cause the computing device to evaluate the target event group include instructions operable to cause the computing device to compute a first distance between the target event group and the non-actionable group, compute a second distance between the target event group and actionable group, and compare the first distance with the second distance to determine if the target event group, including the inbound event, is closer to the actionable group or to the nonactionable group. The first distance is a difference between (i) a first joint entropy value that measures a degree of uncertainty between the target event group and the non-actionable group and (ii) a first mutual information value that measures a degree of mutual dependence between the target event group and the non-actionable group. The second distance is a difference between (i) a second joint entropy value that measures a degree of uncertainty between the target event group and the actionable group and (ii) a second mutual information value that measures a degree of mutual dependence between the target event group and non-actionable group.

In yet another aspect, the invention features means for detecting actionable transaction risks comprising means for grouping an inbound event related to a transaction with a target event group, means for determining an actionable group of events that are deemed high risk and a non-actionable group of non-actionable events that are deemed low risk, and means for evaluating the target event group relative to the actionable and non-actionable groups of events. The means for evaluating the target event group comprising means for computing a first distance between the target event group and the non-actionable group, means for computing a second distance between the target event group and actionable group, and means for comparing the first distance with the second distance to determine if the target event group, including the inbound event, is closer to the actionable group or to the nonactionable group.

Any of the above aspects can include one or more of the following features. In some embodiments, comparing the first distance with the second distance comprises (i) if the first distance is larger than the second distance, identifying the target event group, including the inbound event, as non-actionable, or (ii) if the first distance is smaller than the second distance, identifying the target event group, including the inbound event, as actionable.

In some embodiments, the inbound event is parsed into a plurality of features of the inbound event and one or more of the plurality of features of the inbound event is augmented with additional description. In some embodiments, augmenting one or more of the plurality of features comprises at least one of removing non-relevant data or adding metadata to the corresponding feature. In some embodiments, the first mutual information value is a sum of a plurality of feature-specific mutual information values. Each feature-specific mutual information value computes mutual information between a feature in the plurality of features for the inbound event and the non-actionable group. In some embodiments, the second mutual information value is a sum of a plurality of feature-specific mutual information values. Each feature-specific mutual information value computes mutual information between a feature in the plurality of features for the inbound event and the actionable group.

In some embodiments, the non-actionable group of events include historical transaction events that were adjudicated as non-actionable and the actionable group of events include historical transaction events that were adjudicated as actionable.

In some embodiments, the inbound event is monitored in real time to determine the true actionality of the inbound event and the inbound event is added to one of the actionable group or the non-actionable group based on the determination.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a risk assessment engine, according to some embodiments of the present invention.

FIG. 2 shows a process diagram of an exemplary computerized method for assessing risks associated with events across an enterprise utilizing the risk assessment engine of FIG. 1, according to some embodiments of the present invention.

### DETAILED DESCRIPTION

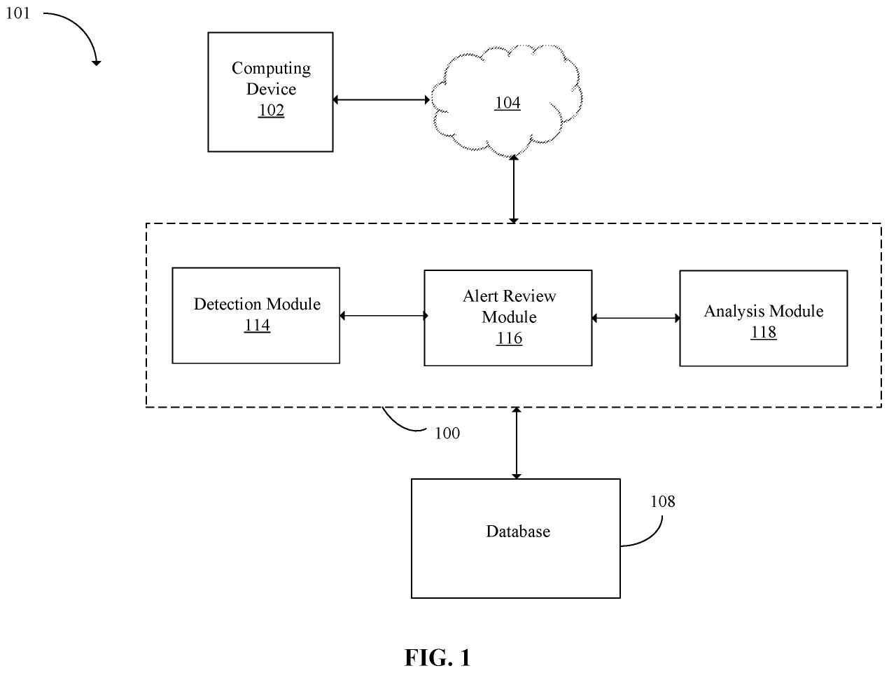

FIG. 1 shows an exemplary diagram of a risk assessment engine 100 used in a computing system 101 for assessing risks associated with events across an enterprise, according to some embodiments of the present invention. As shown, the computing system 101 generally includes at least one client computing device 102, a communication network 104, the risk assessment engine 100, and one or more databases 108.

The client computing device 102 connects to the communication network 104 to communicate with the risk assessment engine 100 and/or the database 108 to provide inputs and receive outputs relating to the process of vocally signing a digital document as described herein. For example, the computing device 102 can provide a detailed graphical user interface (GUI) that allows a user to input transaction event data and display risk adjudication/evaluation results using the analysis methods and systems described herein. Exemplary computing devices 102 include, but are not limited to, telephones, desktop computers, laptop computers, tablets, mobile devices, smartphones, and internet appliances. In some embodiments, the computing device 102 has voice playback and recording capabilities. It should be appreciated that other types of computing devices that are capable of connecting to the components of the computing system 101 can be used without departing from the scope of invention. Although FIG. 1 depicts a single computing device 102, it should be appreciated that the computing system 101 can include any number of client devices.

The communication network 104 enables components of the computing system 101 to communicate with each other to perform the process of vocal signature of digital documents. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 101 to communicate with each other.

The risk assessment engine 100 is a combination of hardware, including one or more processors and one or more physical memory modules and specialized software engines that execute on the processor of the risk assessment engine 100, to receive data from other components of the computing system 101, transmit data to other components of the computing system 101, and perform functions as described herein. As shown, the processor of risk assessment engine 100 executes a detection module 114, an alert review module 116, and an analysis module 118. These sub-components and their functionalities are described below in detail. In some embodiments, the various components of the risk assessment engine 100 are specialized sets of computer software instructions programmed onto a dedicated processor in the risk assessment engine 100 and can include specifically-designated memory locations and/or registers for executing the specialized computer software instructions.

The database 108 is a computing device (or in some embodiments, a set of computing devices) that is coupled to and in communication with the risk assessment engine 100 and is configured to provide, receive and store various types of data received and/or created for performing voice signature of digital documents, as described below in detail. In some embodiments, all or a portion of the database 108 is integrated with the risk assessment engine 100 or located on a separate computing device or devices. For example, the database 108 can comprise one or more databases, such as MySQL™ available from Oracle Corp. of Redwood City, Calif.

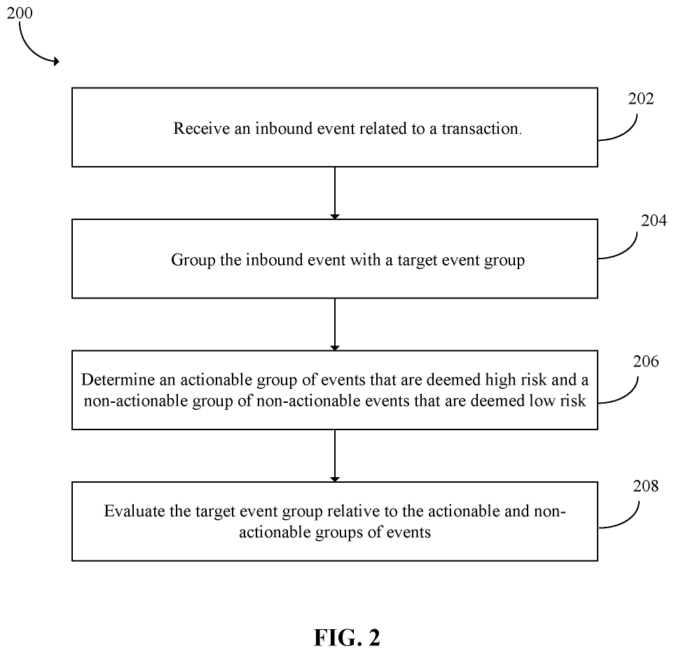

FIG. 2 shows a process diagram of an exemplary computerized method 200 for assessing risks associated with events across an enterprise utilizing the risk assessment engine 100 of FIG. 1, according to some embodiments of the present invention. The method 200 starts with the risk assessment engine 100 receiving an inbound event defined by multiple data elements associated with that event (step 202). An inbound event can be a transaction request with an enterprise. Exemplary data elements of an inbound event include date of the event, time of the event, location of the event, where the event was detected, and past events and relationships of other entities (e.g., customers) that the event was found on and related to. For example, an event can be a United States citizen making a wire request to a financial institution to send money to Nigeria in an amount exceeding $10,000. In this case the data elements of this event include citizenship of the originating country (the U.S.), outbound wire country (Nigeria), outbound wire entity (Ali Wildlife Sanctuary), wire amount ($11,000), debit card country (Nigeria), debit card description (Lagos State, Nigeria), debit amount ($252), account type (J), network of requester ($100,000-$500,000).

The detection module 114 is configured to process this event and determine whether a potential risk exists that requires downstream review. In some embodiments, the detection module 114 defines behavior-based models and/or rule-based detection filters to determine if an alert should be generated for an inbound event. Exemplary behavior-based models include artificial intelligence (AI), machine learning (ML) and/or natural language processing (NLP) models that are trained to detect risky features in an inbound event. In some embodiments, rule-based detection filters can generate an alert if the associated event meets certain condition(s). As an example, an alert can be generated for any wire request that meets one or more predefined conditions, such as the country of origin of the wire request being on a suspect list of countries and the wire amount exceeding a predefined threshold value. For instance, an alert can be generated by the detection module 114 in relation to the exemplary wire transfer request event provided above based on (i) the outbound country Nigeria being on a suspect country list and/or (ii) the wire request amount exceeding $10,000.

After an alert is generated for an inbound event, the detection module 114 of the risk detection engine 100 forwards the alerted event to the alert review module 116 of the risk assessment engine 100 for at least one of (i) data augmentation to enrich information included in the event, and/or (ii) event grouping (step 204). The alert review module 116 can employ existing institutional knowledge (e.g., available profile details) to expand on and clarify one or more data elements defining the event. The enrichment process generally permits the automated capture and inclusion of event details when available, thereby enriching data related to an event and improving the subsequent event grouping process based on similarity. In some embodiments, augmenting one or more of the data elements of an alerted event including at least one of removing non-relevant data or adding metadata to a data element. Using the wire transfer request example provided above, the alert review module 116 can add more information describing the outbound wire entity, such as if the entity is a known high risk entity. The alert review module 116 can also add information regarding whether the account from which the wire transfer request is made is linked to a corporate account with other known issues. In some embodiments, each data element in an alerted event is scored to determine its relative risk level, thereby forming a risk signature for the alerted event.

In some embodiments, the alert review module 116 is configured to group the augmented alerted event with one of several target groups, where each target group includes one or more events that are similar to each other. The risk assessment engine 100 can maintain these target groups in the database 108. Classification of an inbound event with one of the target groups can be determined based on how similar the augmented data elements of the inbound event are with the data elements of the events in that group. For example, a similarity metric can be computed between the inbound event and each of the target groups to make this classification decision. In general, as new alerted events are received by the alert review module 116, the alert review module 116 can group each event with other events in one of the target groups, thereby dynamically updating these target groups over time (e.g., over a one-year period). In alternative embodiments, the alerted event is not classified or is in its own event group with no other similar events in the same group.

In addition, the analysis module 118 of the risk assessment engine 100 is configured to determine (i) an actionable group of similar events that have been adjudicated in real life as require escalation and/or identified as true positives because they are high risk in real life and (ii) a non-actionable group of similar events that have been adjudicated in real life as false positives (or non-actionable) because they are low risk in real life (step 206). In some embodiments, the actionable group of events has an overall higher risk score than that of the non-actionable group of events. In some embodiments, these actionable and non-actionable groups are created in real time or near real time from historical results occurred within a predefined time period, such as from a prior one year worth of results. More specifically, each non-actionable group can include one or more historical transaction events that were adjudicated as non-actionable and each actionable group can include one or more historical transaction events that were adjudicated as actionable. In some embodiments, data elements of these actionable and non-actionable similar events are additionally enriched using the enrichment process described above.

After the actionable and non-actionable event groups are formed (from step 206), the analysis module 118 proceeds to evaluate the entire target group to which the inbound event belongs (or the alert event itself if no group assignment/classification were made) relative to the actionable and non-actionable groups (step 208). This evaluation is based on determining what information in the target group/event is similar and what is not against each of these actionable and non-actionable groups. The evaluation can be done on the basis of information points, where each information point comprises an information category that is the same or similar between the inbound event and the actionable/non-actionable groups. In some embodiments, a first distance between the target group/event (denoted as “X”) and the non-actionable event group (denoted as “B”) is calculated. The first distance, which is denoted as “Dxb,” can be calculated as a difference between a first joint entropy value and a first mutual information value. The first joint entropy value, which is denoted as H(X; B), measures the degree of uncertainty between the target group/event and the non-actionable group. The first mutual information value, which is denoted as I (X; B), measures a degree of mutual dependence between the target group/event and the non-actionable group. Equation 1 below summarizes how Dxb can be calculated:

Dxb=H(X,B)−I(X;B) Equation 1

Similarly, a second distance between the target group/event (denoted as “X”) and the actionable event group (denoted as “A”) is also calculated. The second distance, which is denoted as “Dxa,” can be calculated as a difference between a second joint entropy value and a second mutual information value. The second joint entropy value, which is denoted as H(X; A), measures the degree of uncertainty between the target group/event and the actionable group. The second mutual information value, which is denoted as I (X; A), measures a degree of mutual dependence between the target group/event and the actionable group. Equation 2 below summarizes how Dxa can be calculated:

Dxa=H(X,A)−I(X;A) Equation 2

In some embodiments, the first joint entropy value H(X; B) and the second joint entropy value H(X; A) are calculated using the following exemplary equation:

$$H ( X ) = - {\sum }_{i = 0}^{n - 1} P ( {x}_{i} ) * {log}_{2} ( P ( {x}_{i} ) ) \qquad Equation 3$$

In some embodiments, the first mutual information value I (X; B) and the second mutual information value I (X; B) are calculated using the following exemplary equation:

$$I ( X ; Y ) = log ( \frac{P ( X , Y )}{P ( X ) P ( Y )} ) \qquad Equation 4$$

In some embodiments, each of the first or second mutual information values for an event is a summation of multiple mutual information values calculated for the respective ones of the data elements defining that event. Each mutual information value for a data element computes mutual information between that specific data element of the event and the non-actionable group (as a part of the first mutual information value calculation) or the actionable group (as a part of the second mutual information value calculation). In some embodiments, evaluating an entire target group of multiple alert events against the actionable/non-actionable groups may be advantageous because the entire target group is treated as a single informative entity with one distance calculated relative to each of the actionable and non-actionable groups. This significantly reduces computation time and cost. If there are data element collisions between any two events of the same target group (e.g., one account owner of an event is from Canada, but another account owner of another event is from the USA), the target group will get the mutual information contribution from both features.

The analysis module 118 is further configured to compare the first distance Dxb with the second distance Dxa to determine if the target group/event is cognitively closer to the actionable group or to the non-actionable group, based on which the target group/event is categorized as either actionable or non-actionable. For example, if the first distance is larger than the second distance, the target group/event is identified as non-actionable. Alternatively, if the first distance is smaller than the second distance, the target event group/event is classified as actionable.

After a target group/event is classified as either actionable or not actionable using the analytical approach described above at step 208, the analysis module 118 can forward the adjudicated group/event to other modules of the risk assessment engine 100 for automated triaging. For example, the adjudicated group can be sent for further investigation or escalated directly if it is deemed to be actionable and a case can be automatically created. In some embodiments, further data enrichment is applied to these events for further investigation.

Even though the instant risk detection system and method are explained in the context of financial transactions, a person of ordinary skill in the art understands that the same risk assessment system and method can be applied in other contexts where events need to be categorized as either actionable or non-actionable based on their predicted risks. In some embodiments, the actionable and non-action event groups (formed from step 206) are continuously or periodically updated to include recently adjudicated events, thereby improving the accuracy of actionality predictions using the method 200 of FIG. 2. For example, events across an organization can be monitored in real time to determine their true actionality and added to the actionable group or the non-actionable group based on the determinations.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer-implemented method for detecting actionable transaction risks, the method comprising:
grouping, by the computing device, an inbound event related to a transaction with a target event group;
determining, by the computing device, an actionable group of events that are deemed high risk and a non-actionable group of non-actionable events that are deemed low risk; and
evaluating, by the computing device, the target event group relative to the actionable and non-actionable groups of events, evaluating the target event group comprising:
computing a first distance between the target event group and the non-actionable group, the first distance being a difference between (i) a first joint entropy value that measures a degree of uncertainty between the target event group and the non-actionable group and (ii) a first mutual information value that measures a degree of mutual dependence between the target event group and the non-actionable group;
computing a second distance between the target event group and actionable group, the second distance being a difference between (i) a second joint entropy value that measures a degree of uncertainty between the target event group and the actionable group and (ii) a second mutual information value that measures a degree of mutual dependence between the target event group and non-actionable group; and
comparing the first distance with the second distance to determine if the target event group, including the inbound event, is closer to the actionable group or to the nonactionable group.

2. The computer-implemented method of claim 1, wherein comparing the first distance with the second distance comprises:
if the first distance is larger than the second distance, identifying the target event group, including the inbound event, as non-actionable; and
if the first distance is smaller than the second distance, identifying the target event group, including the inbound event, as actionable.

3. The computer-implemented method of claim 1, further comprising:
parsing the inbound event into a plurality of features of the inbound event; and
augmenting one or more of the plurality of features of the inbound event with additional description.

4. The computer-implemented method of claim 3, wherein augmenting one or more of the plurality of features comprises at least one of removing non-relevant data or adding metadata to the corresponding feature.

5. The computer-implemented method of claim 3, wherein the first mutual information value is a sum of a plurality of feature-specific mutual information values, each feature-specific mutual information value computes mutual information between a feature in the plurality of features for the inbound event and the non-actionable group.

6. The computer-implemented method of claim 3, wherein the second mutual information value is a sum of a plurality of feature-specific mutual information values, each feature-specific mutual information value computes mutual information between a feature in the plurality of features for the inbound event and the actionable group.

7. The computer-implemented method of claim 1, wherein the non-actionable group of events include historical transaction events that were adjudicated as non-actionable and the actionable group of events include historical transaction events that were adjudicated as actionable.

8. The computer-implemented method of claim 1, further comprising:
monitoring the inbound event in real time to determine the true actionality of the inbound event; and
adding the inbound event to one of the actionable group or the non-actionable group based on the determination.

9. A computer program product, tangibly embodied in a non-transitory computer readable storage device, for detecting actionable transaction risks, the computer program product including instructions operable to cause a computing device to:
group an inbound event related to a transaction with a target event group;
determine an actionable group of events that are deemed high risk and a non-actionable group of non-actionable events that are deemed low risk; and
evaluate the target event group relative to the actionable and non-actionable groups of events, instructions operable to cause the computing device to evaluate the target event group include instructions operable to cause the computing device to:
compute a first distance between the target event group and the non-actionable group, the first distance being a difference between (i) a first joint entropy value that measures a degree of uncertainty between the target event group and the non-actionable group and (ii) a first mutual information value that measures a degree of mutual dependence between the target event group and the non-actionable group;
compute a second distance between the target event group and actionable group, the second distance being a difference between (i) a second joint entropy value that measures a degree of uncertainty between the target event group and the actionable group and (ii) a second mutual information value that measures a degree of mutual dependence between the target event group and non-actionable group; and
compare the first distance with the second distance to determine if the target event group, including the inbound event, is closer to the actionable group or to the nonactionable group.

10. The computer program product of claim 9, wherein the instructions operable to cause the computing device to compare the first distance with the second distance comprises instructions operable to cause the computing device to:
if the first distance is larger than the second distance, identify the target event group, including the inbound event, as non-actionable; and
if the first distance is smaller than the second distance, identify the target event group, including the inbound event, as actionable.

11. The computer program product of claim 9, further comprising instructions operable to cause the computing device to:
parse the inbound event into a plurality of features of the inbound event; and
augment one or more of the plurality of features of the inbound event with additional description.

12. The computer program product of claim 11, wherein the first mutual information value is a sum of a plurality of feature-specific mutual information values, each feature-specific mutual information value computes mutual information between a feature in the plurality of features for the inbound event and the non-actionable group.

13. The computer program product of claim 11, wherein the second mutual information value is a sum of a plurality of feature-specific mutual information values, each feature-specific mutual information value computes mutual information between a feature in the plurality of features for the inbound event and the actionable group.

14. The computer program product of claim 9, wherein the non-actionable group of events include historical transaction events that were adjudicated as non-actionable and the actionable group of events include historical transaction events that were adjudicated as actionable.

15. The computer program product of claim 9, further comprising instructions operable to cause the computing device to:
monitor the inbound event in real time to determine the true actionality of the inbound event; and
add the inbound event to one of the actionable group or the non-actionable group based on the determination.

16. Means for detecting actionable transaction risks comprising:
means for grouping an inbound event related to a transaction with a target event group;
means for determining an actionable group of events that are deemed high risk and a non-actionable group of non-actionable events that are deemed low risk; and
means for evaluating the target event group relative to the actionable and non-actionable groups of events, the means for evaluating the target event group comprising:
means for computing a first distance between the target event group and the non-actionable group, the first distance being a difference between (i) a first joint entropy value that measures a degree of uncertainty between the target event group and the non-actionable group and (ii) a first mutual information value that measures a degree of mutual dependence between the target event group and the non-actionable group;
means for computing a second distance between the target event group and actionable group, the second distance being a difference between (i) a second joint entropy value that measures a degree of uncertainty between the target event group and the actionable group and (ii) a second mutual information value that measures a degree of mutual dependence between the target event group and non-actionable group; and
means for comparing the first distance with the second distance to determine if the target event group, including the inbound event, is closer to the actionable group or to the nonactionable group.
